(19) United States
(12) Patent Application Publication
(10) Pub. No.: US 2008/0267840 A1
(43) Pub. Date: Oct. 30, 2008

(54) Ozone-water generator

(76) Inventor: Kuo-Chung Yeh, Chung-Li City (TW)

Correspondence Address: TROXELL LAW OFFICE PLLC, Suite 1404, 5205 Leesburg Pike, Falls Church, VA, 22041, US

(21) Appl. No.: 11/790,473

(22) Filed: Apr. 25, 2007

(51) Int. Cl. B01J 19/08

(52) U.S. Cl. 422/186.07

(57) ABSTRACT

An ozone-water generator comprises a machine body, an ozone generator, a gas-liquid mixer and a light-controlled switch. The machine body is employed for holding the ozone generator, the gas-liquid mixer and the light-controlled switch. The ozone generator is connected to the gas-liquid mixer. The gas-liquid mixer is connected to the light-controlled switch. The light-controlled switch comprises a tube, two circuit boards, a movable valve and an elastic device. The movable valve is forwardly and backwardly shiftable within the tube. When the movable valve is shifted by the force of water current, two light-controlled devices on the respective circuit boards can be electrically conducted to form an electrical signal for actuating the ozone generator and thereby mixing the ozone and the liquid. The movable valve is so extremely light in weight that an extremely small force of water current is sufficient to shift the movable valve.

### FIELD OF THE INVENTION

The present invention relates to an ozone-water generator, and more particularly to a light-controlled switch that allows an extremely small force of water current to shift a movable valve for thereby switching on or switching off the ozone-water generator.

### BACKGROUND OF THE INVENTION

Ozone-water generator has found wide application including vegetables and fruit cleaning, sterilization and disinfection. The conventional ozone-water generator has mounted therein a magnetic reed, wherein the magnetic reed is driven by water pressure to allow two conducting plates to electrically connect with each other for forming an electrical signal, which activates an oscillating circuit of a water heater for ignition or a start switch of a pump. The magnetic reed has a weight between about 30 and 50 grams. When the water pressure is too low, the force of water current is insufficient to drive the magnetic reed, and the magnetic reed suffers from the interference caused by water current so it is in an always-on state.

### SUMMARY OF THE INVENTION

A major object of the present invention is to provide a light-controlled switch that replaces the conventional magnetic reed with a movable valve and a light-controlled device. The movable valve is so extremely light in weight that an extremely small force of water current such as about 5 grams is sufficient to shift the movable valve. As a result, the light-controlled device can be turned on or off by displacement of the movable valve to further switch on or switch off other apparatus by the electrical signal. Accordingly, the problem of low water pressure resulting from the inability to activate the working can be solved. Moreover, the ozone-water generator of the present invention is operable under smaller water pressure.

### BRIEF DESCRIPTION OF THE DRAWINGS

These and other features, aspects and advantages of the present invention will become better understood with regard to the following description, appended claims, and accompanying drawings, wherein:

FIG. 1 is an elevational diagram of the present invention;

FIG. 2 is an elevational decomposed diagram showing the inside structure of the present invention;

FIG. 3 is a cross-sectional, decomposed diagram showing the inside structure of the light-controlled switch of the present invention;

FIG. 4 is a cross-sectional diagram showing the movable valve that shelters the light-controlled device of the present invention;

FIG. 5 is a cross-sectional diagram showing the movable valve of the present invention shifted by the water current;

FIG. 6 is a schematic diagram showing a faucet assembled to the ozone-water generator of the present invention; and

FIG. 7 is another schematic diagram showing the faucet assembled to the ozone-water generator of the present invention.

### DETAILED DESCRIPTION OF THE PREFERRED EMBODIMENT

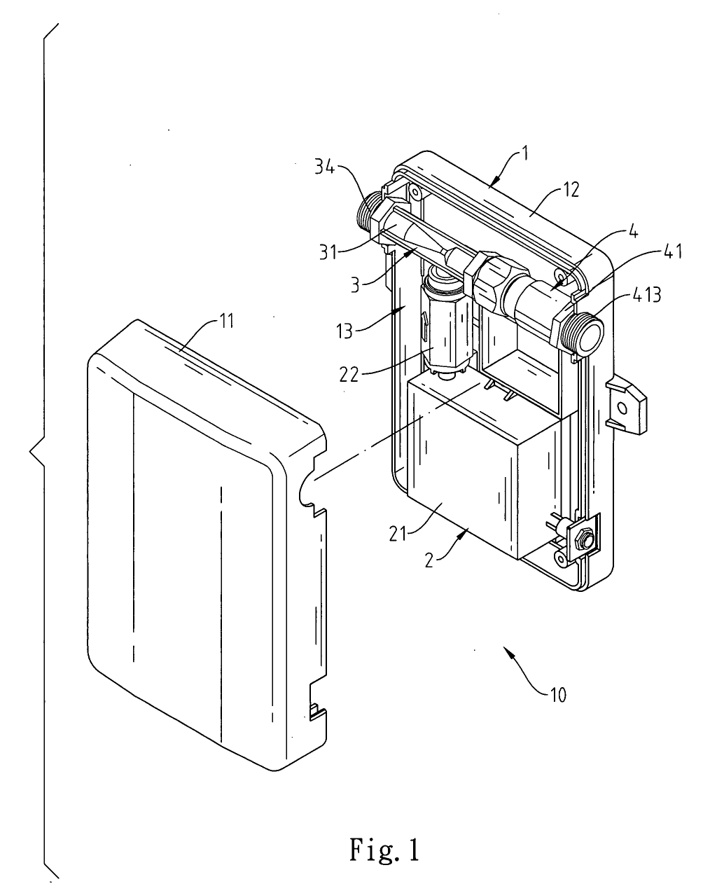

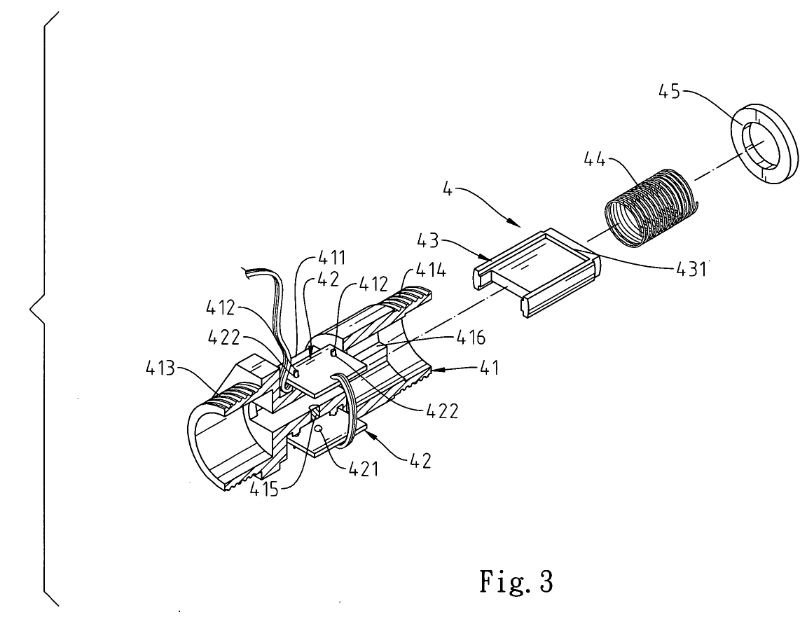

Referring to FIGS. 1 and 3, an ozone-water generator 10 generally comprises a machine body 1, an ozone generator 2, a gas-liquid mixer 3 and a light-controlled switch 4.

The above-mentioned machine body 1 comprises an upper machine case 11, a lower machine case 12 and a holding chamber 13 defined jointly by the upper machine case 11 and the lower machine case 12, wherein the holding chamber 13 is employed for holding the ozone generator 2, the gas-liquid mixer 3 and the light-controlled switch 4.

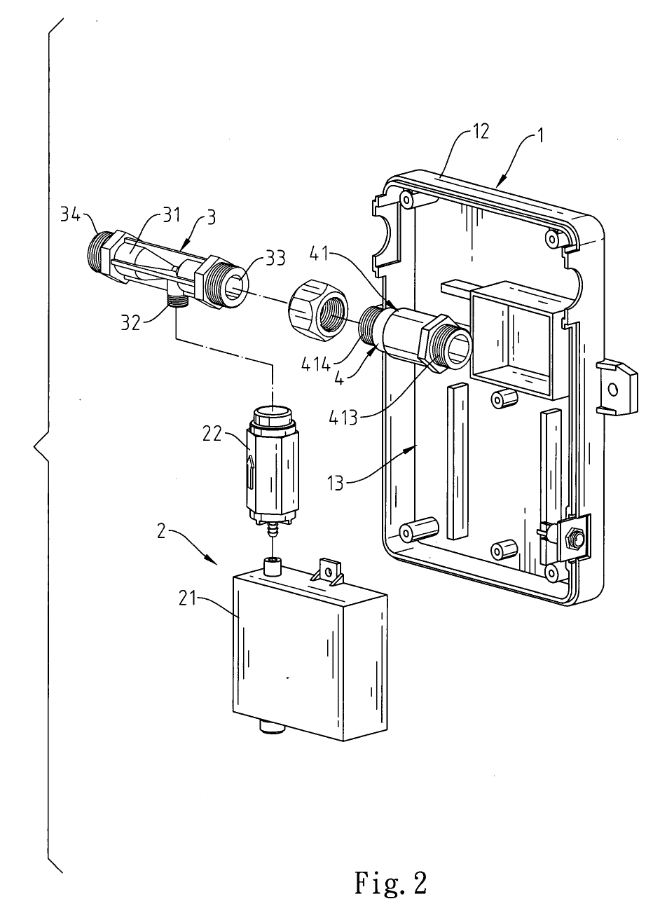

Referring again to FIG. 1 and FIG. 2, the above-mentioned ozone generator 2 has an ozone-generating device 21 and an ozone pipe 22. One end of the ozone pipe 22 is connected to the above-mentioned gas-liquid mixer 3, and the other end of the ozone pipe 22 is connected to the ozone-generating device 21. The ozone-generating device 21 is employed for generating ozone.

Referring again to FIGS. 1 and 2, the gas-liquid mixer 3 has a tube 31, an ozone inlet pipe connector 32 on the lateral of the tube 31 in a radial direction, a liquid inlet 33 on one end of the tube 31 in an axial direction, a mixed liquid outlet 34 on the other end of the tube 31 in the axial direction. The ozone inlet pipe connector 32 is connected to one end of the ozone pipe 22 of the ozone generator 2. The liquid inlet 33 is connected to the above-mentioned light-controlled switch 4.

Referring to FIGS. 2 through 4, the above-mentioned light-controlled switch 4 comprises a tube 41, two circuit boards 42, a movable valve 43, an elastic device 44 and a pad 45.

The tube 41 has an action region 411 on the center. A protrusion part 412 and a corresponding part 415 are mounted on each opposite side of the action region 411 in the radial direction. The corresponding parts 415 are made of a light-transmitting material. The tube 41 has respective openings on both ends for coupling with other apparatus. The tube 41 has an inlet pipe connector 413 and an outlet pipe connector 414 on both ends respectively in the axial direction. The inlet pipe connector 413 is designed for allowing the exterior liquid to enter the tube 41. The outlet pipe connector 414 is designed for connecting with the liquid inlet 33 of the gas-liquid mixer 3. In addition, a guide slot 416 is formed in the inner wall of the tube 41 to allow horizontal movement therein of the movable valve 43 and to prevent the movable valve 43 from being rotated by the water current. Furthermore, the tube 41 can be entirely made of a light-transmitting material. Therefore, in this case, the corresponding parts 415 can be also pervious to the light without further processing.

Each of the circuit boards 42 is constituted by a light-controlled device 421 and an electrical wiring. The circuit board 42 has a reception hole 422 on one end to allow the protrusion part 412 of the tube 41 to be fixedly inserted thereinto. The light-controlled devices 421 are disposed on both sides of the action region 411 of the tube 41 in the radial direction, respectively, and the light-controlled devices 421 are oppositely disposed on the respective outsides of the corresponding parts 415.

The above-mentioned movable valve 43, the elastic device 44 and the pad 45 are coupled to one another and held into the tube 41. The movable valve 43 is mounted within the action region 411 of the tube 41 and it is horizontally shiftable in the guide slot 416. In addition, one end of the movable valve 43 is located against one end of the elastic device 44, and the other end of the elastic device 44 is located against the pad 45. In addition, the movable valve 43 is made of an opaque material lesser than 30 grams. One end of the movable valve 43 is slightly larger than the opening of the action region 411 to prevent the detachment of the movable valve 43 from the outlet pipe connector 414. A retaining plate 431 is mounted on the other side of the movable valve 43, wherein the retaining plate has respective recessed surfaces on the upper and lower sides to enable the liquid flowing thereinto to shift the movable valve 43 by means of the resisting force-formed by the retaining plate 431. In addition, the movable valve 43 is forwardly and backwardly shiftable within the action region 411 by means of the elastic device 44.

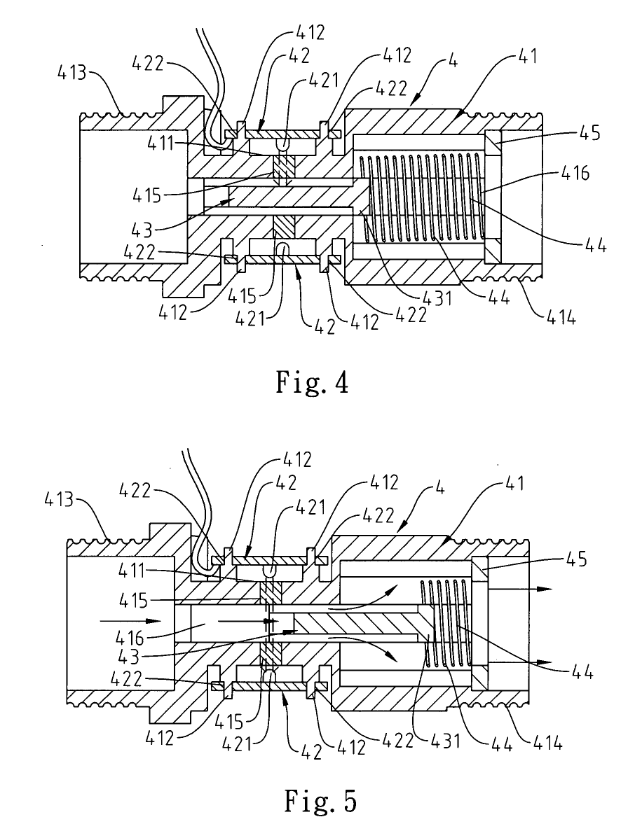

Please refer to FIGS. 3 through 5 for more details. When the ozone-water generator 10 is in the initial state, the movable valve 43 of the tube 41 is located in the action region 411 by means of the elastic force of the elastic device 44. At this moment, the opaque movable valve 43 shelters the light-controlled devices 421 disposed radially on both sides of the action region 411 of the tube 41 from transmitting and receiving signal, as shown in FIG. 4. When the water current flows into the inlet pipe connector 413 to push and forward shift the movable valve 43 to a predetermined position, the oppositely disposed light-controlled devices 421 can detect each other via the corresponding parts 415, which are pervious to the light, to change the signal into ON state from OFF state, as shown in FIG. 5. In such a condition, this signal actuates the ozone generator 2 and enables it to generate ozone. When the water current flows into the gas-liquid mixer 3, the pressure difference inside the gas-liquid mixer 3 creates a suction force to suck the ozone into the gas-liquid mixer 3 automatically for thereby mixing the ozone and the water.

When the water current stops flowing, the water pressure disappears. In such a condition, the opaque movable valve 43 returns to its initial position by means of the elastic force of the elastic device 44 to shelter the light-controlled devices 421 from transmitting and receiving the signal. Therefore, the signal of the light-controlled devices 421 is changed into OFF state from ON state to switch off the ozone generator 2.

The movable valve 43 is so extremely light in weight that an extremely small force of water current such as about 5 grams is sufficient to activate the working of the movable valve 43, thereby effectively improving the inability of low water pressure to activate the working. Besides, the movable valve 43 has a predetermined length so the water current must have a predetermined amount to forward shift the movable valve 43 by a predetermined distance for changing the signal of the light-controlled devices 421 into OFF state from ON state. As a result, the water current must have the predetermined amount in order to actuate the ozone generator 2. In such a design, the small amount of water current is unable to actuate the ozone generator 2, thereby avoiding the waste of energy and preventing the excessive concentration of ozone in water.

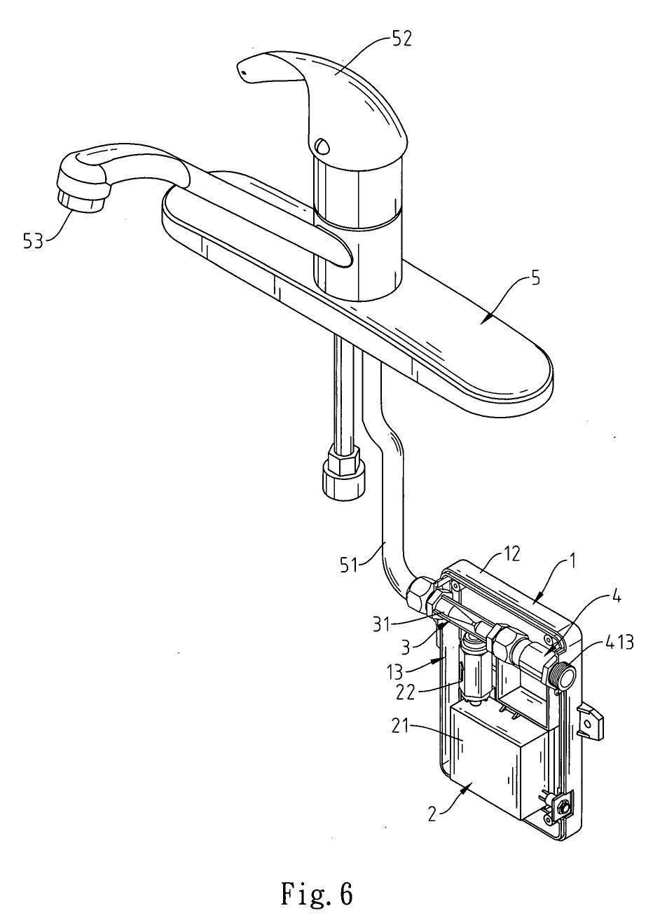

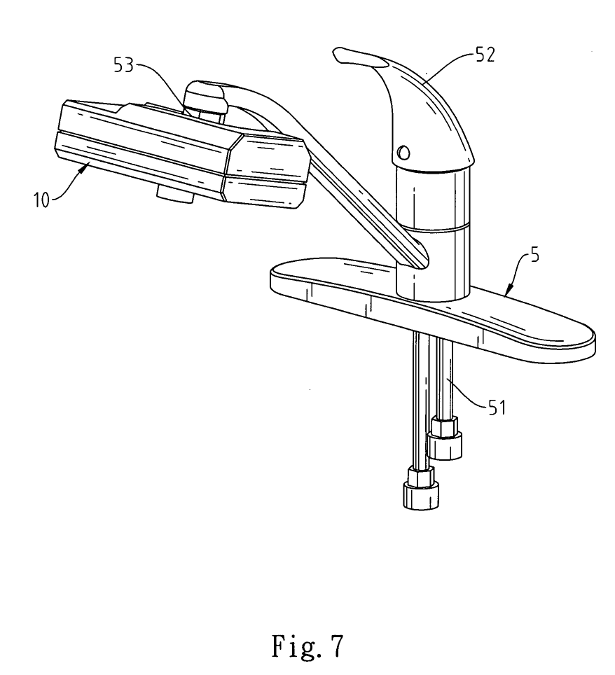

Furthermore, referring to FIG. 6, there is shown a schematic diagram of a faucet assembled to the ozone-water generator 10, wherein the faucet 5 has an inlet port 51, a switch 52 and an outlet port 53. The mixed liquid outlet 34 of the gas-liquid mixer 3 of the present invention is coupled to the inlet port 51. The inlet pipe connector 413 of the tube 41 is connected to the water source so the user just needs to switch on the switch 52 to perform the action of mixing ozone and water. Thereafter, the mixed liquid is drained out from the outlet port 53. Moreover, referring to FIG. 7, there is shown another schematic diagram of the faucet assembled to the ozone-water generator 10, wherein the inlet pipe connector 413 of the tube 41 of the ozone-water generator 10 is coupled to the outlet port 53 of the faucet 5 to achieve the same purposes and effects as the preferred embodiment described above. The redundant description thereof is omitted herein.

What the invention claimed is:

1. An ozone-water generator, comprising:
a machine body for holding an ozone generator, a gas-liquid mixer and a light-controlled switch;
said ozone generator connected to said gas-liquid mixer for generating ozone;
said gas-liquid mixer having a first tube, an ozone inlet pipe connector on the lateral of said first tube in a radial direction, a liquid inlet on one end of said first tube in an axial direction, a mixed liquid outlet on the other end of said first tube in said axial direction, said ozone inlet pipe connector being connected to said ozone generator, said liquid inlet being connected to said light-controlled switch; and
said light-controlled switch comprising a second tube, two circuit boards, a movable valve and an elastic device, said second tube having an action region for holding thereon said movable valve, one end of said movable valve being located against one end of said elastic device, the other end of said elastic device being located against the inside of said second tube, said second tube having two corresponding parts on respective opposite sides in an radial direction, said circuit boards being located on the respective outsides of said corresponding parts, said circuit boards having respective light-controlled devices mounted thereon, said light-controlled devices being oppositely disposed on the respective outsides of said corresponding parts.

2. An ozone-water generator of claim 1, wherein said corresponding parts are made of a light-transmitting material.

3. An ozone-water generator of claim 1, wherein said movable valve is made of an opaque material lesser than 30 grams.

4. An ozone-water generator of claim 1, wherein said light-controlled switch further comprises a pad held in said second tube.

5. An ozone-water generator of claim 1, wherein said second tube is made of a light-transmitting material.
